(19) United States
(12) Patent Application Publication
(10) Pub. No.: US 2024/0394817 A1
(43) Pub. Date: Nov. 28, 2024

(54) BLENDING PREDICTION AND ALLOCATION MODELING FOR EDUCATIONAL DEVELOPMENT GOALS

(71) Applicant: INTERNATIONAL BUSINESS MACHINES CORPORATION, Armonk, NY (US)

(72) Inventors: Chelsea Jean-Mary ISSAC, Alpharetta, GA (US); Niraj Ranjan SHARMA, Kolkata (IN); Jatinder S. JOSHI, Gurgaon (IN); Sanket JAIN, Gurgaon (IN); Sukumar BERI, New Delhi (IN)

(21) Appl. No.: 18/324,516

(22) Filed: May 26, 2023

(51) Int. Cl. G06Q 50/20; G06N 5/022

(52) U.S. Cl. CPC G06Q 50/205; G06N 5/022

(57) ABSTRACT

A method includes: in response to receiving opt-in consent from a student, obtaining, by a processor set, student data associated with the student; monitoring, by the processor set, performance of the student in a course using a predictive machine learning model that predicts a score in the course based on the student data; detecting, by the processor set, a negative trend in the performance of the student based on the monitoring; and in response to detecting the negative trend, matching, by the processor set, the student with a mentor for the course using a matching model.

### BACKGROUND

Aspects of the present invention relate generally to blending prediction and allocation modeling for educational development goals and, more particularly, to methods, systems, and computer program products for offering better co-learning for K-12 students and higher education experienced candidates by blending prediction and allocation modeling approaches and making offerings compatible with the current sustainability development goals (SDGs).

Many people are currently enrolled in educational programs either for basic education or to enhance their skills. There are many varied approaches to helping students with their learning. One such approach involves providing educational guidance through mentors that assist students via advising, explaining, and encouraging.

### SUMMARY

In a first aspect of the invention, there is a computer-implemented method including: in response to receiving opt-in consent from a student, obtaining, by a processor set, student data associated with the student; monitoring, by the processor set, performance of the student in a course using a predictive machine learning model that predicts a score in the course based on the student data; detecting, by the processor set, a negative trend in the performance of the student based on the monitoring; and in response to detecting the negative trend, matching, by the processor set, the student with a mentor for the course using a matching model.

In another aspect of the invention, there is a computer program product including one or more computer readable storage media having program instructions collectively stored on the one or more computer readable storage media. The program instructions are executable to: in response to receiving opt-in consent from a student, obtain student data associated with the student; train a predictive machine learning model that predicts a score in a course; monitor performance of the student in the course using the student data with the predictive machine learning model; detect a negative trend in the performance of the student based on the monitoring; and in response to detecting the negative trend, match the student with a mentor for the course using a matching model.

In another aspect of the invention, there is a system including a processor set, one or more computer readable storage media, and program instructions collectively stored on the one or more computer readable storage media. The program instructions are executable to: in response to receiving opt-in consent from a student, obtain student data associated with the student; train a predictive model that predicts a score in a course, wherein the predictive model comprises a decision tree model; monitor performance of the student in the course using the student data with the predictive model; detect a negative trend in the performance of the student based on the monitoring; and in response to detecting the negative trend, match the student with a mentor for the course using a matching model.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows an exemplary user interface in accordance with aspects of the present invention.

FIG. 4 shows a diagram of an algorithm of a predictive model used to predict student performance in a course in accordance with aspects of the present invention.

FIG. 5 shows an example of using a predictive model to predict a course grade for two students in accordance with aspects of the present invention.

FIG. 6 shows an example of an optimized mentoring schedule for a mentor in accordance with aspects of the present invention.

FIG. 7 shows a flowchart of an exemplary method in accordance with aspects of the present invention.

FIG. 8 shows a flowchart of an exemplary method in accordance with aspects of the present invention.

### DETAILED DESCRIPTION

Aspects of the present invention relate generally to blending prediction and allocation modeling for educational development goals and, more particularly, to methods, systems, and computer program products for offering better co-learning for K-12 students and higher education experienced candidates by blending prediction and allocation modeling approaches and making offerings compatible with the current sustainability development goals (SDGs).

Many people are currently enrolled in educational programs either for basic education or to enhance their skills. However, the impact of quarantine and a global pandemic has had a negative impact on many students' performance and has created a need for a new approach to learning that can help keep students motivated and on track in a supportive environment. Students who learn in this post-education environment often experience alienation due to fewer in-person interactions, exhaustion from external factors such as balancing a job (for working professionals) or dealing with loss during a pandemic (for students), and uncertainty of relevant future job skills due to rapid advancement of technologies. These students may benefit from an enriched learning experience as described in the present disclosure. For example, students can benefit from implementations of the present invention by being able to stay motivated to learn, e.g., by co-learning, exchanging notes on learned material, sharing their experiences, and expanding their network within an organization.

Implementations of the present invention address shortcomings in current educational programs by leveraging artificial intelligence (AI) to: provide an improved online leaning platform that uses AI modeling to match students/mentees with mentors; provide individualized recommendations and intervention steps based on predictions; and incorporate student/mentee feedback into the system to improve the model robustness and reduce bias. In embodiments, a system, method, and computer program product are configured to predict student performance in a course using a machine learning model such as a decision tree model. In a particular exemplary embodiment, the decision tree model comprises a gradient boosted decision tree (GBDT) model. In embodiments, the system, method, and computer program product are configured to provide an improved online leaning platform that uses AI modeling to match students with mentors using an AI algorithm to solve a matching model based on a cost function to provide individualized mentoring and intervention recommendations. In embodiments, the system, method, and computer program product are configured to use the predictive model (e.g., the decision tree model) to predict a student's performance in a course over time, detect a negative trend in the predicted performance, and use the matching model (e.g., the cost function), in response to detecting the negative trend, to determine an optimal match between the student and a mentor. In this manner, embodiments of the invention provide a technical improvement in the field of educational guidance, where the technical improvement comprises using AI models to detect and address a negative trend in student performance. Embodiments of the invention may benefit kindergarten through twelfth grade (K-12) students that are currently enrolled in an online education program and that are experiencing internal and/or external factors that are having a negative impact on the student's performance. Embodiments of the invention may also benefit working professionals or apprentices that are losing the motivation to succeed and are uncertain about completing their certification.

Implementations of the invention provide an improved online leaning platform that provides matching of students using an AI algorithm to provide individualized mentoring and intervention recommendations. Implementations of the invention provide a system and method to predict student performance. Implementations of the invention provide an improved online leaning platform that provides matching of mentors with mentees (e.g., students) based on multiple criteria such as tolerance of three hours' time zone difference, weekend and holiday schedule, etc. Implementations of the invention combine the power of decision trees for prediction of which students are likely to fall behind in the motivation curve, and then to use a MILP algorithm to guide them with optimally designed mentoring sessions along with a feedback loop for intervention and change of mentor if required. The algorithm may be referred to as a Novel Motivational Model. Implementations of the invention use of L1 regularizer as well as a low learning rate to avoid overfitting of the prediction model. Implementations of the invention use several KPIs (key performance indicators) that can be used to predict a drop in motivational level (e.g., poor attendance, static grades, poor cohort performance, poor school performance, no questions asked in email or in class, course fee too high, academic workload too high, job workload too high, lack of practical sessions, not enough interaction with other students of the cohort, etc.). Other exemplary KPIs include: course grades, job offers, college acceptance letters, hours met with volunteers, volunteer hours, attrition rate, enrollment, graduation rate, diversity rate, and job offers. Implementations of the invention align these KPIs with user personas such as student, faculty, mentor, admin, faculty, and leadership. Implementations of the invention predict the students whose motivation level is dropping significantly as well as those students whose motivation and engagement levels are constantly rising. Implementations of the invention categorize the ‘in-between’ cases as those who do need some kind of mentoring. Implementations of the invention make optimum use of a mentor's available time by enforcing constraints in the matching model, such as to enforce a three hours tolerance window to incorporate the time zone difference of mentor(s) and mentee(s).

In an exemplary implementation, students and key stakeholders opt into the system by registering in a portal via a mobile application or desktop website. In this example, after opting-in, students submit their educational institution, program, anticipated graduation level and transcripts. Students are then tagged based on education curriculum, certification, grade level, and interests. In this example, students choose to be assigned a mentor. Students may login into the system to view their current course performance and notifications. In embodiments, the system dynamically monitors the performance of the student and keeps track of volunteer hours. In embodiments, the system uses relevant inputs to match mentors and students (e.g., mentees) and computes a prediction of student performance. In embodiments, a model is used to identify a best course of action for the student. Students are then matched with a mentor based on course, preferences, etc. In embodiments, the students and mentors can provide feedback on whether the course of action is appropriate for them.

In an exemplary implementation, the improved online leaning platform includes a registration app in the beginning for students, mentees, and mentors. Embodiments of the improved online leaning platform may also include a website or app for performance tracking of each student. In embodiments, the system identifies the candidate students for whom mentoring can be provided, based on performance trends, etc. In embodiments, a student uses a decision box to indicate whether the student wants an algorithm-based recommendation for a mentor. In embodiments, an app records or measures the outcome of the mentoring session(s) to the mentee. In embodiments, there is a mechanism to provide feedback of mentor sessions.

Implementations of the invention are necessarily rooted in computer technology. For example, the step of monitoring performance of the student in a course using a predictive machine learning model that predicts a score in the course based on the student data is computer-based and cannot be performed in the human mind. Training and using a machine learning model are, by definition, performed by a computer and cannot practically be performed in the human mind (or with pen and paper) due to the complexity and massive amounts of calculations involved. For example, datasets used with gradient boosted decision tree models may contain hundreds of millions of rows, thousands of features, and a high level of sparsity. Given this scale and complexity, it is simply not possible for the human mind, or for a person using pen and paper, to perform the number of calculations involved in training and/or using a machine learning model.

It should be understood that, to the extent implementations of the invention collect, store, or employ personal information provided by, or obtained from, individuals (for example, academic records, personal information, etc.), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as educational guidance code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

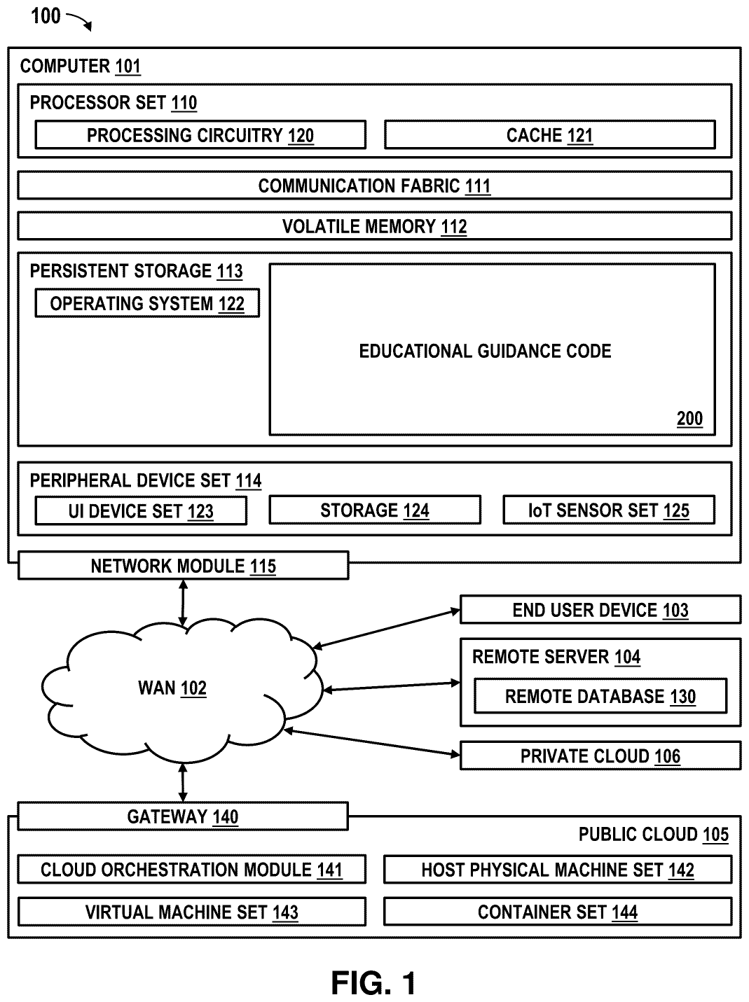

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

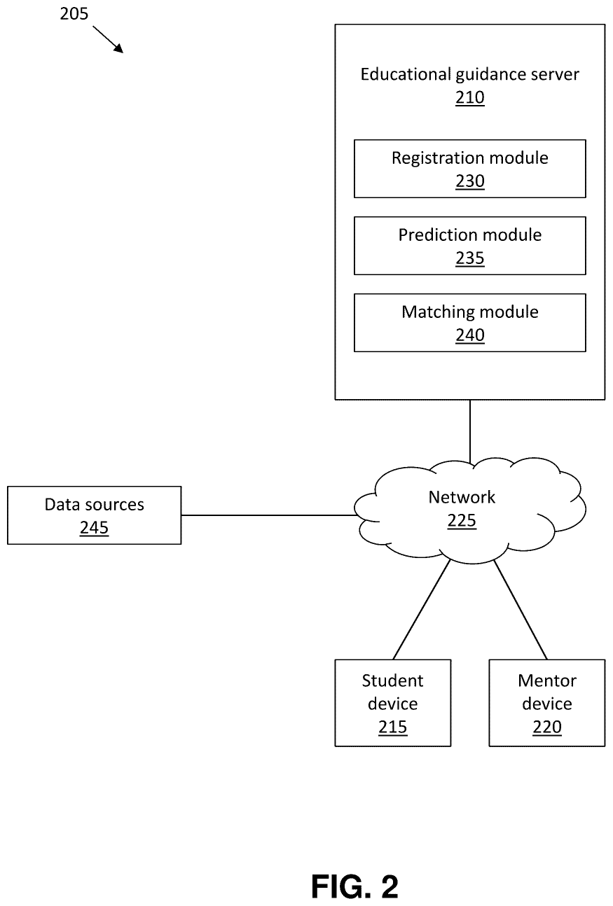

FIG. 2 shows a block diagram of an exemplary environment 205 in accordance with aspects of the invention. In embodiments, the environment 205 includes an educational guidance server 210 that is configured to provide an improved online leaning platform to perform the inventive methods as described herein. In one example, the educational guidance server 210 comprises one or more instances of the computer 101 of FIG. 1. In another example, the educational guidance server 210 comprises one or more virtual machines or containers running on one or more instances of the computer 101 of FIG. 1.

In embodiments, the educational guidance server 210 communicates with at least one student device 215 and at least one mentor device 220 via a network 225. Each of the student device 215 and the mentor device 220 may comprise an instance of the end user device 103 of FIG. 1. There may be any number of student devices 215 and mentor devices 220 for any number of students and mentors, although only one of each device is shown for simplicity. A student may utilize more than one student device 215. Similarly, a mentor may utilize more than one mentor device 220. The network 225 may comprise the WAN 102 of FIG. 1. In this manner, the educational guidance server 210 provides an improved online leaning platform that users access using their computing devices 215 and 220.

In embodiments, the educational guidance server 210 of FIG. 2 comprises a registration module 230, prediction module 235, and matching module 240, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The educational guidance server 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the registration module 230 is configured to register students and mentors with the system. In embodiments, registration is computer based and involves a student or mentor using an app or website on their device (e.g., 215 or 220) to provide registration information to the educational guidance server 210. In embodiments, registration includes the students and mentors affirmatively opting-in to the system, and may include an explanation of what information is collected by the system and how the information is used by the system. In embodiments, registration includes a student providing their educational institution, program, anticipated graduation level, and transcripts to the educational guidance server 210. In one example, this comprises the student sending documents from the student device 215 to the server. In another example, this comprises the student using the student device 215 to grant access by the educational guidance server 210 to one or more data sources 245 where this information is stored. In embodiments, registration includes a mentor providing their educational areas of expertise and their calendar data to the educational guidance server 210. In one example, this comprises the mentor using the mentor device 220 to grant access by the educational guidance server 210 to the mentor's calendar information stored on the mentor device 220. In another example, this comprises the mentor using the mentor device 220 to grant access by the educational guidance server 210 to the mentor's calendar information stored on one or more data sources 245.

In accordance with aspects of the invention, the prediction module 235 is configured to predict student performance in a course using a predictive model. In embodiments, the predictive model comprises a decision tree model, which is a type of machine learning model. In a particular exemplary embodiment, the predictive model comprises a gradient boosted decision tree (GBDT) model. In embodiments, the predictive model is trained to output a predicted course grade for a particular student in a particular course based on student data for the particular student. In embodiments, the student data comprises: quiz grades on this student in the particular course; hours met with a mentor for the course; major or adverse life events for this student during the course; and mentor evaluation scores. In embodiments, the predictive model is trained using supervised learning using a training dataset that includes student data labeled with an actual course grade for plural students that previously enrolled in the course. In accordance with aspects of the invention, the prediction module 235 is configured to use the predictive model to predict student performance in a course at different points in time and to detect a negative (e.g., downward) trend in the predicted performance for a student.

In accordance with aspects of the invention, the matching module 240 is configured to match a student with a mentor using an AI algorithm. In embodiments, in response to the prediction module 235 detecting a negative trend in the predicted performance for a particular student for a particular course, the matching module 240 uses a matching model to determine an optimum matching of this student with a mentor for this course. In embodiments, the matching model comprises a cost function that is solved using mixed integer linear programming (MILP). In embodiments, the cost function includes parameters, costs, and constraints. In embodiments, the matching module 240 solves the cost function using a parameter estimation algorithm, where solving the cost function yields values of parameters that define an optimal matching of the student with a mentor.

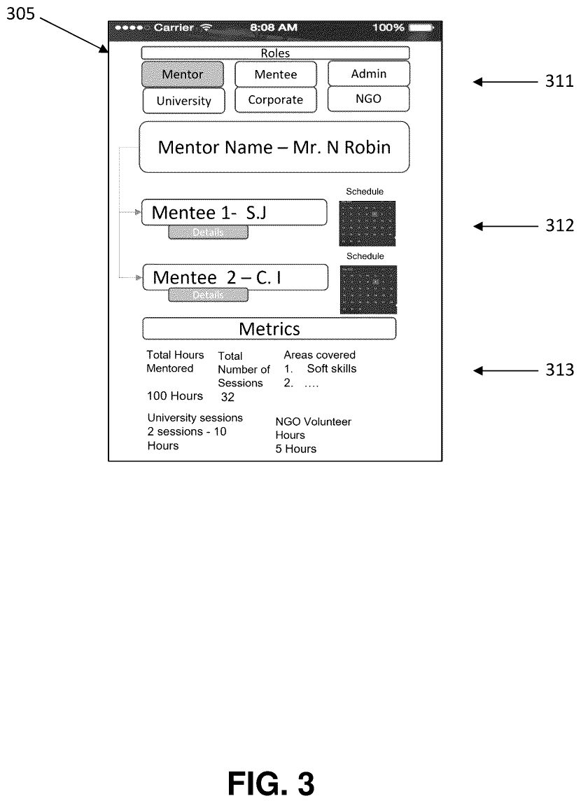

FIG. 3 shows an exemplary user interface (UI) 305 of an app (e.g., mobile application) that may be used in accordance with aspects of the present invention. The app may be run on the student device 215 or mentor device 220 of FIG. 2, for example. In embodiments, the UI 305 includes a first area 311 where the user may provide input to select their role, a second area 312 that shows the user's schedule in the selected role, and a third area 313 that shows the user's metrics in the selected role. In the example shown in FIG. 3, the user has selected the role of mentor in the first area 311. In this example, the second area 312 shows the mentor's name and the mentor's schedule with different mentees. In an exemplary usage, a mentor may use the UI 305 to monitor the mentee's amount of mentoring, for example to determine whether the mentee is in compliance with a goal or program.

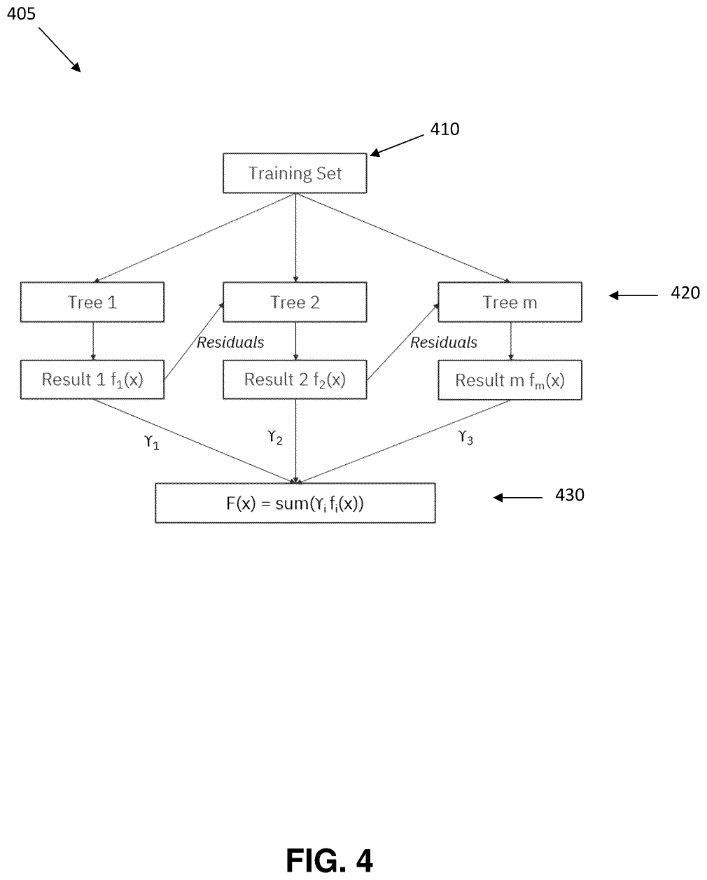

FIG. 4 shows a diagram of an algorithm 405 of the predictive model used by the prediction module 235 to predict student performance in a course in accordance with aspects of the present invention. In this example, the algorithm 405 is based on decision trees for regression and may comprise a gradient boosted decision tree (GBDT) model to predict course performance.

In embodiments, the inputs to the predictive model include student data {xᵢyᵢ}=ᵢ₌₁ⁿ (e.g., the training set 410) used to predict course grade and a differential loss function L(yᵢ, F(x)) used to evaluate how well the course grade is predicted. In the student data, xᵢ represents individual student measurements such as quiz grades, hours met with mentor, major or adverse life event, and mentor evaluation scores, where n represents the number of students in the dataset. In embodiments, students submit quiz grades, number of hours with mentors and other relevant factors such as life circumstances at the time of review. In the student data, yᵢ represents the individual student course grade. In the model, i represents a student sample number in the dataset. The differential loss function L(yᵢ, F(x)) is used to evaluate how well the model predicts the course grade and is the sum of squared residuals divided by two as shown in Equation 1.

$$L ( {y}_{i} , F ( x ) ) = \frac{1}{2} {( {y}_{i} - F ( x ) )}^{2} \qquad ( 1 )$$

In Equation 1, yᵢ is the observed value or their current grade and F(x) is the predicted course grade. As a result, the loss function of Equation 1 can be summarized in words as shown in Equation 2.

$$\frac{1}{2} {( Observed course grade - Predicted course grade )}^{2} \qquad ( 2 )$$

In embodiments, a first step (e.g., step 1) of using the predictive model includes initializing the model with a constant value:

$${F}_{0} ( x ) = {arg min}_{γ} {\sum }_{i = 1}^{n} L ( {y}_{i ,} γ )$$

to find an initial predicted value that minimizes the sum of squared residuals. For this model, the constant value is shown in Equation 3 as:

$${F}_{0} ( x ) = {arg min}_{γ} {\sum }_{i = 1}^{n} \frac{1}{2} {( {y}_{i} - γ )}^{2} \qquad ( 3 )$$

In Equation 3, γ is the predicted course grade and yᵢ is the observed or current grade for student sample number i.

In embodiments, a second step (e.g., step 2) of using the predictive model includes for each tree m=1 to M, performing the following operations A through D:

(A) Compute pseudo-residuals

$${r}_{i m} = - {[ \frac{\partial L ( {y}_{i} , f ( {x}_{i} ) )}{\partial F ( {x}_{i} )} ]}_{F ( x ) = {F}_{m - 1} ( x )} i = 1 , … , n .$$

(B) Fit a regression tree to the rᵢₘ values and create terminal regions Rⱼₘ, for j=1 . . . Jₘ.

(C) For j=1 . . . Jₘ, compute

$${γ}_{j m} = {arg min}_{γ} {\sum }_{{x}_{i} ϵ {R}_{ij}} L ( {y}_{i} , {F}_{m - 1} ( {x}_{i} ) + γ ) for j = 1 … {J}_{m} .$$

(D) Update Fₘ(x)=Fₘ₋₁(xᵢ)+νΣⱼ₌₁^{J}^{ₘ}γⱼₘI(x∈Rⱼₘ).

For operation (A), rᵢₘ is the pseudo-residual that gets computed for student sample number i for tree m. M is the total number of trees 420 in FIG. 4, which is set to 100 in one example.

In embodiments, the pseudo-residual is calculated by taking the derivative of the loss function with respect to the predicted value as shown in Equation 4.

$$- \frac{\partial L ( {y}_{i} , F ( {x}_{i} ) )}{\partial F ( {x}_{i} )} = - ( {y}_{i} - F ( {x}_{i} ) ) \qquad ( 4 )$$

As a result, the pseudo-residual of Equation 4 can be summarized in words as shown in Equation 5.

$$- ( Observed course grade - Predicted course grade ) \qquad ( 5 )$$

In embodiments, pseudo-residuals are computed for all n student samples in the dataset in operation A.

For operation (B), a regression tree is built to predict the residuals. The terminal regions are where j is each leaf in the tree and m is the individual tree.

For operation (C), the system computes the predicted residual, γ, for each leaf j that minimizes the sum of squared residuals using only the samples (i.e., students) that are within a terminal region or xᵢ∈Rᵢⱼ.

In the model, yᵢ is the observed or current grade for a student sample, Fₘ₋₁(xᵢ) is the course grade prediction from the previous tree based on xᵢ representing individual student measurements, γ is the predicted residual, j is the leaf, and Jₘ is the final leaf of the tree.

For operation (D), a new course grade prediction is made for each student sample based on the course grade prediction from the previous tree, the sum of the output values for all the leaves that a student sample can be found in within the new tree, and ν, a learning rate to lower the variance of our model. In one example, ν can be set to 0.1.

In embodiments, a third step (e.g., step 3) of using the predictive model includes outputting Fₘ(x), the predicted course grade, shown at 430 in FIG. 4. In this manner, the algorithm 405 may be used to predict a grade for a student in a course.

In embodiments, the predictive model makes use of M number of decision trees to improve the accuracy of the overall model that predicts the course performance of each student as well as for the entire set of students or mentees. Decision trees are advantageous because they aid in explainability and interpretability of results. Embodiments implement Big Data use case, and the predictive model comprises a gradient boosted decision tree (GBDT) to handle the massive amounts of data. Embodiments avoid using neural networks since neural networks are considered opaque and thus lack the explainability and interpretability provided by a decision tree model. As described with respect to the algorithm 405, the boosting model is used by building a model on the training dataset (training set 410) and the next model is built to rectify error in the previous model, and so on. The predictive model made in this manner increases understanding by showing which factors most affect specific outcomes. In embodiments, the predictive model decides course grades based on four main input data: student information provided such as age, gender, geography, etc.; course grades such as GPA (Grade Point Average), quiz grades, and course performance; adverse life events, such as accidents or ill health which may cause a disruption to studies; and a mentor evaluation of the student. In embodiments, the predictive model identifies candidate students (e.g., large drop in motivation, performance) by preparing hundreds of derived attributes or feature vectors (via data pre-processing) which includes steps such as missing value imputation and preparing variables about slope and trends of student performance in each subject or course. For instance, if a student is showing a consistent downward trend in a particular subject with a high slope value, then this student needs improvement in that subject, for which a mentor can be recommended. In embodiments, the app shows the trends for each subject taken by the student in a semester of curriculum.

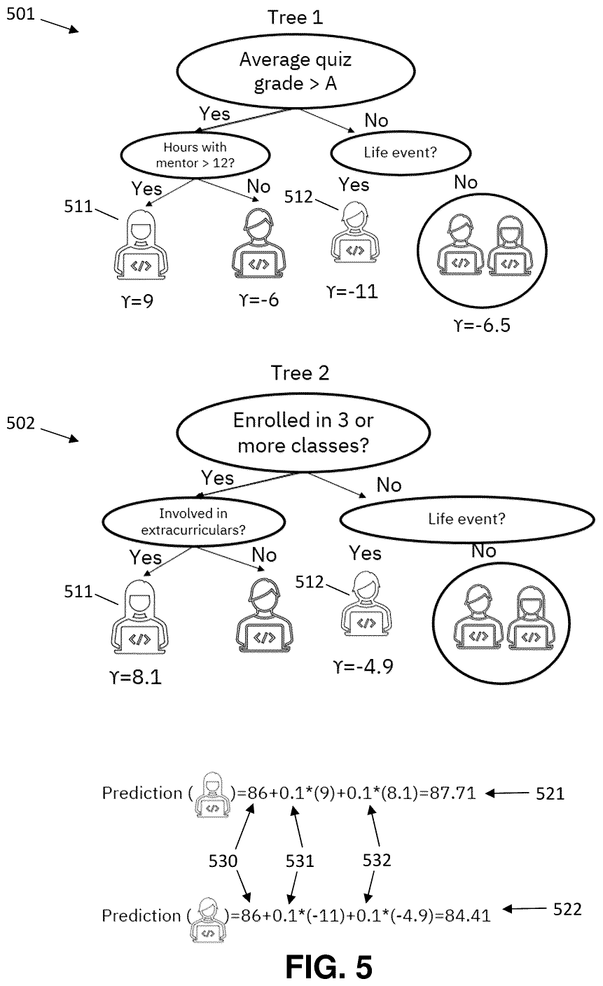

FIG. 5 shows an example of using the predictive model to predict a course grade for two students in accordance with aspects of the present invention. In this example, the predictive model is shown with only two trees, e.g., Tree 1 at 501 and Tree 2 at 502; however, the predictive model may include many more numbers of trees, such as 100 or more trees as described with respect to FIG. 4.

In the example shown in FIG. 5, Tree 1 at 501 provides a predicted residual γ=9 for the first student 511 and a predicted residual γ=−11 for the second student 512. In the example shown in FIG. 5, Tree 2 at 502 provides a predicted residual γ=8.1 for the first student 511 and a predicted residual γ=−4.9 for the second student 512. The predicted residual for each leaf of each tree is determined by training the model in the manner described with respect to FIG. 4.

In the example shown in FIG. 5, the predicted course grade for the first student 511 is shown at 521 as being 87.71. In this example, that score is a sum of: a constant 530 determined during training as described with respect to FIG. 4, a first factor 531 multiplied by the predicted residual γ=9 for the first student 511 from Tree 1 at 501, and a second factor 532 multiplied by the predicted residual γ=8.1 for the first student 511 from Tree 2 at 502.

In the example shown in FIG. 5, the predicted course grade for the second student 512 is shown at 522 as being 87.71. In this example, that score is a sum of: the constant 530, the first factor 531 multiplied by the predicted residual γ=−11 for the second student 512 from Tree 1 at 501, and the second factor 532 multiplied by the predicted residual γ=−4.9 for the second student 512 from Tree 2 at 502.

A comprehensive learning and mentoring system in accordance with aspects of the invention may be used to efficiently manage the mentors and student cohort across an entire course program and to deliver value and improve measurable performance of students from year to year. Embodiments determine the right timing and nature of mentoring to increase mentor availability and student access, thereby increasing the student's chance of success. Embodiments achieve this using a matching model that is configured to determine an optimum matching of a student with a mentor for a course in response to detecting a negative trend in the predicted performance for the student for the course. In embodiments, the matching model comprises a cost function, an example of which is shown in Equation 6.

$$T C = {\sum }_{i = 1}^{i = I} {\sum }_{t = 1}^{t = T} ( {C}_{-} {PLQ}_{i , t} + {C}_{-} {I}_{i} + {C}_{-} {W}_{w} + {C}_{-} {PL}_{i , t} + {C}_{-} {PL}_{w , t} ) \qquad ( 6 )$$

Equation 6 represents an exemplary expression for cost optimization defined for a mentee's (i.e., a student's) scheduling optimization. In embodiments, the matching module 240 uses one or more parameter estimation algorithms to solve Equation 6 to minimize the value of the total cost TC. In this example, the decision variable is MAT_{i,t,s,w}: if mentoring is performed with mentee i by mentor w at time t {0,1).

In this example, sets include:
T: Set of planning horizon 1 . . . t
I: Set of students (mentees) 1 . . . i
W: Set of mentors 1 . . . w
S: Set of time zones 1 . . . s

In this example, parameters include:
AL_{i,t}: Availability of student i in time t
AL_{w,t}: Availability of mentor w in time t
CAPᵢ: Maximum capacity of mentee i
ALL_{i,t}: Actual allocation of mentee i
C_PLQ_{i,t}: Cost of lost productivity (in $) of mentee i if not allocated before scheduled quiz in time t
C_PL_{w,t}: Cost of lost productivity (in $) of mentor hours w due to non-allocation of mentee in time t
P_BK_{i,w,t}: Probability of failure of mentor w matching i in time t
C_lᵢ: Cost of mentee hours (in $) i
C_W_{w}: Cost of mentor hours (in $) w
C_EL_{w}: Cost of early replacement (in $) of mentor w
PV_U_{w,t}: Productive value (in $) per session of mentor w in time t
LF_{i,t}: Expected span or duration of mentoring i by any mentor in W in time t
TZₜ: If time zone is favorable=1. Otherwise, 0 in time t
Fᵢ: Number of mentoring sessions during the planning horizon for mentee i
WA_{w,t}=1 if mentor w is available (not on leave) on the day t otherwise 0
IA_{i,t}: =1 if mentor i is available (not on leave) on the day t otherwise 0
s_{w}: Time zone of mentor
sᵢ: Time zone of student

As noted above, the decision variable to solve for is whether mentoring is performed with mentee (i.e., student) i by mentor w at time {0,1). In this example, the following costs are used to solve the optimization problem of Equation 6.

Cost of lost productivity (e.g., in dollars) of mentee if not allocated before scheduled quiz w in time t given by Equation 7.

$${C}_{-} {PLQ}_{i , t} = {PV}_{-} {U}_{w , t} \times {P}_{-} {BK}_{i , w , t} \times ( A L {L}_{i , t} - C A {P}_{w} \times ( 1 - A {L}_{i , t} ) ) i ∈ I , t ∈ T \qquad ( 7 )$$

Cost of mentee hours given by Equation 8.

$${C}_{-} {I}_{i , t} = {C}_{-} {I}_{i} \times {P}_{-} {BK}_{i , w , t} i ∈ I , t ∈ T \qquad ( 8 )$$

Cost of mentoring given by Equation 9.

$${C}_{-} {W}_{w , t} = {C}_{-} {W}_{w} \times ( 1 - {P}_{-} {BK}_{i , w , t} ) \times {MAT}_{i , t , s , w} i ∈ I , t ∈ T \qquad ( 9 )$$

Cost of loss productivity ($) due to quiz given by Equation 10.

$${C}_{-} {PL}_{i , t} = {PV}_{-} {U}_{w , t} \times {P}_{-} {BK}_{i , w , t} \times ( {ALL}_{i , t} - {CAP}_{w} \times ( 1 - A {L}_{w , t} ) ) i ∈ I , t ∈ T \qquad ( 10 )$$

Cost of lost productivity of mentor hours due to non-allocation of mentee given by Equation 11.

$${C}_{-} {PL}_{w , t} = {C}_{-} {EL}_{w} \times max \{ L {F}_{i , t} - t , 0 \} i ∈ I , t ∈ T \qquad ( 11 )$$

As noted above, the objective in this example is minimizing the total cost TC of Equation 6. In this example, the minimizing is performed subject to the following constraints.

Constraint T1: In a day, only one mentee can be schedule to a mentor, as shown by:

$${\sum }_{s = 1}^{s = S} {\sum }_{w = 1}^{w = W} {MAT}_{i , t , s , w} \leq 1 ∀ i in I , t in T$$

Constraint T2: A schedule should be maintained F=planning horizon (in days)/session recommended (in days), as shown by:

$${\sum }_{t = 1}^{t = T} {MAT}_{i , t} = {F}_{i} ∀ i ∈ I$$

Constraint T3: A mentoring session should be scheduled when time zone is favorable=1, as shown by:

MAT_{i,t,w}=Wtₜ∀i∈I,t∈T,w∈W

Constraint T4: Mentoring can be done if it is not a public holiday, as shown by:

MAT_{i,t,s,w}=0∀w in W,tin WSA,i∈I,s∈S

Constraint T5: Mentoring can be done if mentors are available, as shown by:

MAT_{i,t,s,w}=0∀w in WA,t∈T,s∈S

Constraint T6: Mentoring can be done if mentees are available, as shown by:

MAT_{i,t,s,w}=0∀w in IA,t∈T,i∈I,s∈S

Constraint T7: Time Zone tolerance within ±3 hours, as shown by:

$$\vert {s}_{w} - {s}_{i} \vert \leq 3 , s ∈ S , w ∈ W , i ∈ I$$

An additional constraint that can be used in this example relates to whether the student prefers a same-gender mentor. This can be accommodated by defining an exclusion list as per business rules. For example, if a student i does not want a mentor of the opposite gender (example a), then the new set that should be used for matching mentors with that student is as given by:

$$W ∖ \{ a \} = \{ x : x ∈ W , ∼ ( x ∈ \{ a \} ) \}$$

In this example, it can be seen that the matching model may be based on determining a solution that minimizes a total cost function (e.g., Equation 6) that includes a decision variable that is based on whether mentoring is performed with mentee (i.e., student) i by mentor w at time {0,1). The total cost function may comprise sets including: planning horizon, mentees (i.e., students), mentors, and time zones. The total cost function may comprise parameters including: availability of mentee (i.e., student), mentor, capacity of mentee, cost of lost productivity, probability of failure of mentor matching, cost of mentee and mentor hours, cost of early replacement of mentor, productive value of mentor per session, expected span or duration of mentoring, favorable time zones, number of mentoring sessions. The total cost function may comprise costs including: lost productivity of mentee (i.e., student) if not allocated before scheduled quiz, mentee hours, mentoring, lost productivity due to quiz, lost productivity of mentor hours due to non-allocation of mentee. The total cost function may comprise constraints including: only one mentee (i.e., student) can be scheduled to a mentor in a day, a schedule should be maintained within planning horizon, a mentoring session should be scheduled when time zone is favorable, mentoring can only be done if it's not on a public holiday and if mentors and mentees are available, mentoring sessions should only be scheduled for a mentor and mentee that are within three hours of each other. In embodiments, the total cost function is solved using multiple integer linear programming (MILP). Implementations of the invention are not limited to using the cost function of Equation 6, and other matching models using other cost functions may be used.

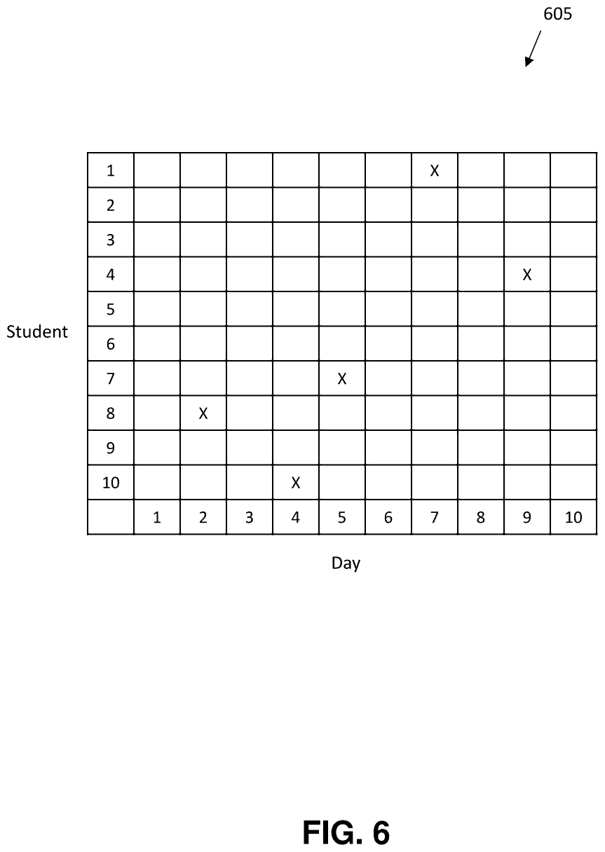

FIG. 6 shows an example of an optimized mentoring schedule 605 for a mentor in accordance with aspects of the present invention. In this example, the schedule 605 shows different days on the horizontal axis and different students on the vertical axis. In this example, the prediction module 235 uses the predictive model to detect a negative trend in the performance of students 1, 4, 7, 8, and 10. In this example, the matching module 240 uses the matching model to determine optimal dates for the students 1, 4, 7, 8, and 10 to meet with the mentor for mentoring. In this example, the optimal date for student 1 is day 7. In this example, the optimal date for student 4 is day 9. In this example, the optimal date for student 7 is day 5. In this example, the optimal date for student 8 is day 2. In this example, the optimal date for student 10 is day 4.

In embodiments, the matching module 240 automatically schedules the determined mentoring dates for both the mentor and the students in the app. For example, for the mentor, the dates and students shown in the schedule 605 may be represented with scheduling data shown in the second area 312 of the UI 305 on the mentor device 220. Similarly, for respective ones of the students, the second area 312 of the UI 305 on their student device 215 may be updated to reflect their scheduling with this mentor as indicated in the schedule 605.

The prediction module 235 may have detected a negative trend in the performance of other ones of the students (e.g., one or more of students 2, 3, 5, 6, and 9). However, the matching module 240 may have scheduled these other students with a different mentor for this course. It is also possible that other ones of the students (e.g., one or more of students 2, 3, 5, 6, and 9) do not have a negative trend in their performance such that they are not matched with any mentor for this course.

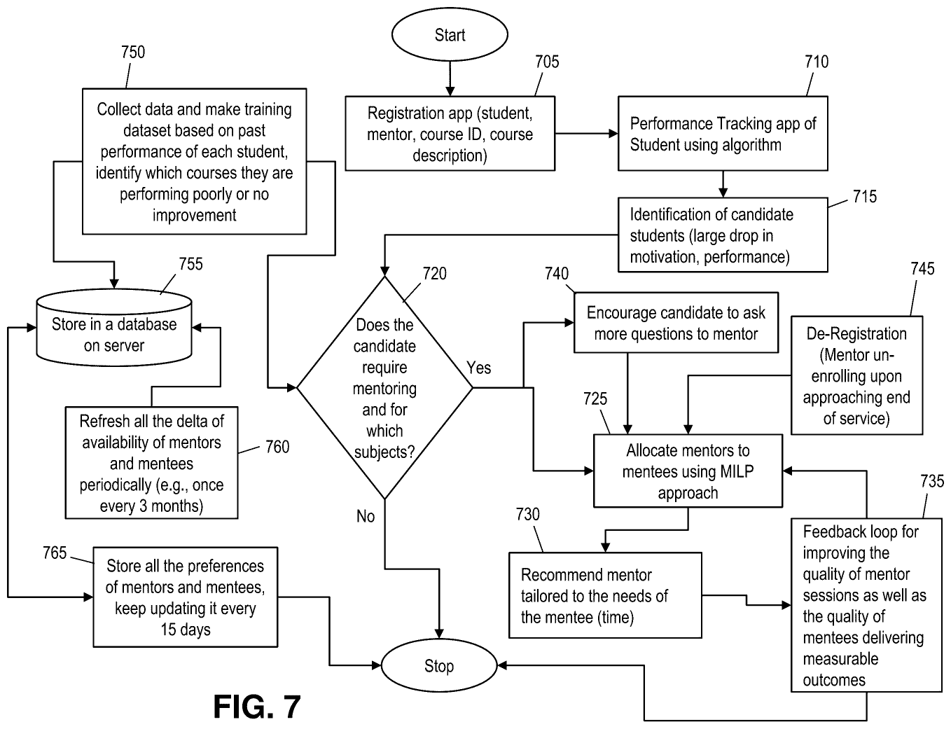

FIG. 7 shows a flowchart of an exemplary method in accordance with aspects of the present invention. Steps of the method may be carried out in the environment of FIG. 2 and are described with reference to elements depicted in FIG. 2.

At step 705, the system receives registration from a student. The registration may include opt-in and providing access to student data. At step 710, the a performance tracking app of the system permits the user to track their performance. Step 710 may comprise the prediction module 235 predicting course scores for the student using the predictive model for each course and the student data. At step 715, the system identifies candidate students for mentoring. In embodiments, the prediction module 235 identifies students for which it has detected a negative trend in predicted course performance using the predictive model. At step 720, the system determines whether the candidate requires mentoring and for which subjects. If no, then the process ends. If yes, then at step 725 the system allocates a mentor to the student using the matching model that is solved using MILP. At step 730, the system recommends the mentor to the student. At step 735, the system receives feedback for improving the quality of mentor sessions as well as the quality of mentees delivering measurable outcomes. Optionally, at step 740 the system encourages (e.g., prompts) the student to ask more questions to the mentor. At step 745, the system de-registers a mentor, for example when a mentor unenrolls from the program. At step 750, the system collects data and makes a training dataset based on past performance of each student. At step 755, the system saves the collected data in a database. At step 760, the system refreshes all the delta (e.g., differences) of availability of mentors and students periodically (e.g., once every 3 months). At step 765, the system stores all the preferences of mentors and mentees, e.g., updating it every 15 days.

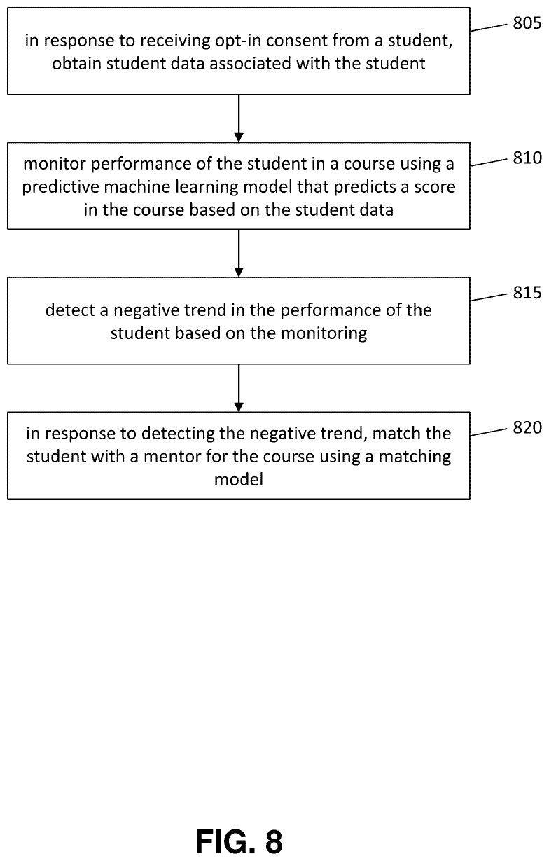

FIG. 8 shows a flowchart of an exemplary method in accordance with aspects of the present invention. Steps of the method may be carried out in the environment of FIG. 2 and are described with reference to elements depicted in FIG. 2.

At step 805, in response to receiving opt-in consent from a student, the system obtains student data associated with the student. In embodiments, and as described herein, the registration module 230 receives opt-in and obtains student data.

At step 810, the system monitors performance of the student in a course using a predictive machine learning model that predicts a score in the course based on the student data. In embodiments, and as described herein, the prediction module 235 uses the predictive model to predict scores for students in a course. The prediction module 235 may predict scores for students using their student data at different times throughout the course, thus creating a time series for each student.

At step 815, the system detects a negative trend in the performance of the student based on the monitoring of step 810. In embodiments, and as described herein, the prediction module 235 may analyze the time series of predicted scores for each student to detect whether a student has a negative trend in their predicted score for the course. A threshold slope over a predefined period of time may be used to define a negative trend. As such, the analyzing may comprise comparing the slope of the time series of predicted scores for a student over a period of time to the threshold slope.

At step 820, in response to detecting the negative trend at step 815, the system matches the student with a mentor for the course using a matching model. In embodiments, and as described herein, the matching module 240 uses the matching model to match a student with a mentor.

In embodiments of the method, the predictive machine learning model comprises a decision tree model. In embodiments of the method, the decision tree model comprises a gradient boosted decision tree model. In embodiments of the method, the decision tree model receives the student data as input, the student data comprising: quiz grades; hours met with any mentor for the course; life events for the student during the course; and mentor evaluation scores. In embodiments of the method, the decision tree model outputs a predicted score for the student based on the student data. In embodiments of the method, the decision tree model determines the predicted score by aggregating results from plural different decision trees.

In embodiments of the method, the matching comprises identifying the mentor and a mentoring date. In embodiments of the method, the matching model comprises a cost function. In embodiments of the method, the matching comprises solving the cost function using multiple integer linear programming.

In embodiments of the method, the cost function includes parameters comprising one or more selected from a group consisting of: availability of the student; availability of the mentor; capacity of student; cost of lost productivity; probability of failure of mentor matching; cost of student hours; cost of mentor hours; cost of early replacement of the mentor; productive value of the mentor per session; expected span or duration of mentoring; favorable time zones; and number of mentoring sessions.

In embodiments of the method, the cost function includes costs comprising one or more selected from a group consisting of: cost of lost productivity of the student if not allocated before a scheduled quiz; cost of student hours; cost of mentoring; cost of lost productivity due to quiz; cost of lost productivity of mentor hours due to non-allocation of the student.

In embodiments of the method, the cost function includes constraints based on one or more selected from a group consisting of: a number of students that can be scheduled to the mentor in a single day; maintaining a schedule with a planning horizon; time zones; holidays; availability of mentors; availability of students; and time zone tolerance within a number of hours.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
in response to receiving opt-in consent from a student, obtaining, by a processor set, student data associated with the student;
monitoring, by the processor set, performance of the student in a course using a predictive machine learning model that predicts a score in the course based on the student data;
detecting, by the processor set, a negative trend in the performance of the student based on the monitoring; and
in response to detecting the negative trend, matching, by the processor set, the student with a mentor for the course using a matching model.

2. The method of claim 1, wherein the predictive machine learning model comprises a decision tree model.

3. The method of claim 2, wherein the decision tree model comprises a gradient boosted decision tree model.

4. The method of claim 2, wherein
the decision tree model receives the student data as input, the student data comprising: quiz grades; hours met with any mentor for the course; life events for the student during the course; and mentor evaluation scores;
the decision tree model outputs a predicted score for the student based on the student data; and
the decision tree model determines the predicted score by aggregating results from plural different decision trees.

5. The method of claim 1, wherein the matching comprises identifying the mentor and a mentoring date.

6. The method of claim 1, wherein the matching model comprises a cost function.

7. The method of claim 6, the matching comprises solving the cost function using multiple integer linear programming.

8. The method of claim 6, the cost function includes parameters comprising one or more selected from a group consisting of: availability of the student; availability of the mentor; capacity of student; cost of lost productivity; probability of failure of mentor matching; cost of student hours; cost of mentor hours; cost of early replacement of the mentor; productive value of the mentor per session; expected span or duration of mentoring; favorable time zones; and number of mentoring sessions.

9. The method of claim 8, the cost function includes costs comprising one or more selected from a group consisting of: cost of lost productivity of the student if not allocated before a scheduled quiz; cost of student hours; cost of mentoring; cost of lost productivity due to quiz; cost of lost productivity of mentor hours due to non-allocation of the student.

10. The method of claim 9, the cost function includes constraints based on one or more selected from a group consisting of: a number of students that can be scheduled to the mentor in a single day; maintaining a schedule with a planning horizon; time zones; holidays; availability of mentors; availability of students; and time zone tolerance within a number of hours.

11. A computer program product comprising one or more computer readable storage media having program instructions collectively stored on the one or more computer readable storage media, the program instructions executable to:
in response to receiving opt-in consent from a student, obtain student data associated with the student;
train a predictive machine learning model that predicts a score in a course;
monitor performance of the student in the course using the student data with the predictive machine learning model;
detect a negative trend in the performance of the student based on the monitoring; and
in response to detecting the negative trend, match the student with a mentor for the course using a matching model.

12. The computer program product of claim 11, wherein the predictive machine learning model comprises a decision tree model.

13. The computer program product of claim 12, wherein
the decision tree model receives the student data as input;
the decision tree model outputs a predicted score for the student based on the student data; and
the decision tree model determines the predicted score by aggregating results from plural different decision trees.

14. The computer program product of claim 11, wherein the matching model comprises a cost function that includes parameters, costs, and constraints.

15. The computer program product of claim 14, the matching comprises minimizing the cost function using multiple integer linear programming.

16. A system comprising:
a processor set, one or more computer readable storage media, and program instructions collectively stored on the one or more computer readable storage media, the program instructions executable to:
in response to receiving opt-in consent from a student, obtain student data associated with the student;
train a predictive model that predicts a score in a course, wherein the predictive model comprises a decision tree model;
monitor performance of the student in the course using the student data with the predictive model;
detect a negative trend in the performance of the student based on the monitoring; and
in response to detecting the negative trend, match the student with a mentor for the course using a matching model.

17. The system of claim 16, wherein the decision tree model comprises a gradient boosted decision tree model.

18. The system of claim 16, wherein
the decision tree model receives the student data as input;
the decision tree model outputs a predicted score for the student based on the student data; and
the decision tree model determines the predicted score by aggregating results from plural different decision trees.

19. The system of claim 16, wherein the matching model comprises a cost function that includes parameters, costs, and constraints.

20. The system of claim 19, the matching comprises minimizing the cost function using multiple integer linear programming.
